(19) United States
(12) Patent Application Publication
(10) Pub. No.: US 2026/0112530 A1
(43) Pub. Date: Apr. 23, 2026

(54) AN IMPROVED TRANSMITTER COIL

(71) Applicant: Griffith Air Partners Pty Ltd, Griffith, New South Wales (AU)

(72) Inventor: Angelo Battaglano, Griffith (AU)

(21) Appl. No.: 19/117,026

(22) PCT Filed: Sep. 28, 2023
(86) PCT No.: PCT/AU2023/050943

§ 371 Date: Mar. 28, 2025

(30) Foreign Application Priority Data
Sep. 30, 2022 (AU) 2022902834

(51) Int. Cl. H01F 27/06; G01V 3/10; G01V 3/165; H01F 27/28

(52) U.S. Cl. CPC H01F 27/06; G01V 3/10; G01V 3/165; H01F 27/28

(57) ABSTRACT

The present invention relates to a transmitter coil that is for use in aerial surveying. The transmitter coil of the present invention is made from structural elements that both give the coil its structural strength and integrity and its magnetic field by way of passing electricity through the structural elements. No extra wires are required to be wrapped around the circumference of the transmitter coil. In the preferred embodiment there are three turns of conductive loops forming a single circuit or coil which is connected to the power source outlets of the transmitter. The present invention provides a structurally sound conductive loop of 700 m2 in area and a capacity to carry 400 A of current to generate the magnetic field required for aerial surveying of underground mineral deposits.

### PRIORITY CLAIM

The present application claims priority from 2022902834, filed in Australia on 30 Sep. 2022. The contents of the priority application are hereby incorporated herein by reference.

### TECHNICAL FIELD

The field of the present invention is in the area of transmitter coils used to generate magnetic fields for electromagnetic field surveying and geotechnical mapping.

### BACKGROUND

The field of electromagnetic field surveying includes various surveying techniques that can be undertaken to generate detailed geologic maps. Such surveys are often conducted to identify geological formations deep underground. Electromagnetic field surveying can be performed in a number of different ways including time domain electromagnetic systems (TDEM) and frequency domain electromagnetic systems (FDEM). In a TDEM system a pulse of current applied to the transmitter coil during an on period, generates a primary field and is then turned off during an off period. The secondary signal is measured by the receiver during this off period. The decay of the secondary signal can be used to infer aspects of the geology of the ground that reflected the secondary signal. In FDEM systems the transmitter coil transmits an electromagnetic signal at multiple frequencies at all times while the receiver measures secondary signals generated in the ground surveyed.

Electromagnetic surveying can be conducted on the ground using hand held equipment. However, airborne surveying is a popular method of electromagnetic surveying. Large areas of land can be surveyed whilst an aircraft travels close to the ground, carrying a suspended array of transmitter coil, transmitter/power source and receiver.

FIG. 1 depicts a prior art EM field survey assembly comprising a helicopter which is towing a transmitter coil and associated transmitter and receiver. FIG. 2 depicts how the transmitter coil emits a primary field (solid lines) and how the receiver picks up reflected or secondary field (broken lines) that are generated in the ground.

The magnetic field of the transmitter coil is proportional to its magnetic dipole moment. The magnetic dipole moment of a coil is the product of N, the number of turns, I the current, and A the coil area. The stronger the magnetic field generated by the transmitter coil the better the resulting images. However, making the coil area larger or introducing more turns or heavier gauge wire to carry more current, increases the weight and/or drag of the towed assembly.

This places practical limits on how strong a field can be generated by a transmitter coil of a certain size and weight.

Prior art transmitter coils are traditionally formed from a rigid skeleton upon which, or inside of which, are located the insulated wires which are connected to the transmitter and which generate the magnetic field. The rigid skeleton needs to be strong enough for the apparatus to withstand forces whilst it is flying.

It is an object of an invention to provide an improved transmitter coil that is both rigid and also offers a high magnetic moment, but does so without significantly increasing its weight]

### DISCLOSURE OF THE INVENTION

In a first aspect of the invention there is provided a transmitter coil adapted for use in aerial electromagnetic surveying wherein the transmitter coil comprises at least one structural member that is configured to form at least one conductive loop and adapted to have current from a transmitter module pass through the at least one structural member to generate a magnetic moment.

Preferably the transmitter coil is comprised of a plurality of conductive loops.

Even more preferably there are a plurality of structural members.

Preferably the plurality of structural members comprises a plurality of structural elements that are both rigid and conductive and wherein each structural element form part of the plurality of conductive loops.

More preferably each structural member has two joining end plates at either end of the plurality of structural elements and wherein the end plates are made from a non-conductive material and wherein each end plate is used to connect one structural member with a nearby structural member.

Still more preferably the structural elements from two adjacent structural elements joined by their respective non-conductive end plates are in electrical connection by way of conductive bolts that extend through the non conductive end plates and connect flange portions of the structural elements.

Preferably the structural elements are separated by insulating spacers.

More preferably the number of conductive loops is three and the number of structural elements per structural member is three.

Preferably the plurality of structural members form an almost complete circle comprising three separate conductive loops and a cross over member, where the cross over member is adapted to conduct the current between the structural elements such that they form one conductive circuit or path that has three winds or turns around the transmitter coil.

More preferably the cross over member comprises:
three insulated structural elements that conduct current with their adjacent and connected structural elements in adjacent and connected structural members but that contain a central insulator which prevents the current flowing through the insulated structural elements and where the central insulator divides the insulated structural elements into two electrically insulated portions, and
wires for connecting
   a first portion of a first insulated structural element to a first terminal of the power source (transmitter),
   a second portion of the first insulated structural element to a first portion of the second insulated structural element;
   a second portion of the second insulated structural element to the first portion of the third insulated structural element; and
   from the second portion of the third insulated structural element to the other terminal of the power source (transmitter).

The transmitter coil of claim 10 wherein there are 19 structural members and 1 cross over member provided of equal length and wherein the structural members and cross over member have end plates angled at approximately 99 degrees relative to the structural elements such that when connected by their end plates, the transmitter coil is substantially circular with a diameter of 15 metres.

Preferably the structural elements are aluminium pipes and wherein each structural member weighs around 11 kg in total.

Preferably the total weight of the transmitter coil is approximately 220 kg.

Preferably the total current through the conductive elements is 400 amps.

According to a second aspect of the invention there is provided a surveying apparatus comprising:
a transmitter coil comprising at least one structural member that is configured to form at least one conductive loop and adapted to have current from a transmitter module pass through the at least one structural member to generate a magnetic moment;
at least one generator for generating power;
the transmitter for generating a primary field through the transmitter coil,
a receiver for receiving a secondary field generated by the primary field.

Further or embodiments of the invention may be disclosed herein or may otherwise become apparent to the person skilled in the art through the disclosure herein. These and other embodiments are considered to fall within the scope and object of the invention.

### DESCRIPTION OF FIGURES

Embodiments of the present invention will now be described in relation to figures, wherein:

FIG. 1. is a depiction of the prior art apparatus during aerial electromagnetic surveying;

FIG. 2 is a depiction of the prior art methods and apparatus used to conduct aerial electromagnetic surveying where the magnetic field lines are indicated in the figure;

FIG. 3 is a top view of the transmitter coil comprising the first aspect of the invention.

FIG. 4 is a close-up view of the portion A of a crossover member forming part of the transmitter coil of FIG. 1;

FIG. 5 is a perspective view of two structural segments of the transmitter coil of FIG. 3;

FIG. 6 is a close up view of the portion C B of FIG. 5;

FIG. 7 is a close up view of the portion B C of FIG. 5; and

FIG. 8 is a side view of a structural member.

### DETAILED DESCRIPTION OF PREFERRED EMBODIMENTS

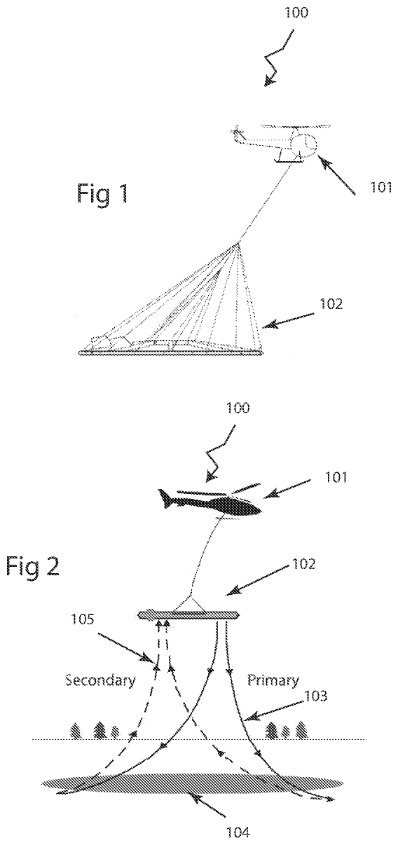

Referring to FIG. 1 and FIG. 2 there is depicted a prior art electromagnetic aerial surveying assembly 100 comprising a helicopter 101 from which is suspended a towed survey rig 102. Rig 102 is comprised of a generator or generators, transmitter coil, transmitter and receiver. The generator/s generates the raw power needed by the transmitter which modulates the power signal and delivers it to the transmitter coil which generates a primary magnetic field 103. After a brief time interval, the receiver is used to measure the strength of the secondary field 105 that is generated by the interaction of the primary field 103 and underground formations 104 which may include mineral deposits.

Generating a strong primary field 103 is dependent on many factors including the power of the generator, transmitter and the form of, and how much current can be delivered through, the transmitter coil. Specifically, the magnetic dipole moment is dependent on the number of turns (conductive loops) in the transmitter coil, its area and the current (amps) that runs through the coil. Increasing any of those variables generally adds significant amount of weight to the towed assembly which in turn, makes it more difficult to use in practice.

The object of the present invention is to provide a transmitter coil where the structural elements are also the conductive elements. By utilizing the structural elements that provide strength and rigidity to the shape of the transmitter coil as conductors, more current can be passed through the coil without the weight having to increase, thereby increasing the efficiency of the towed survey assembly.

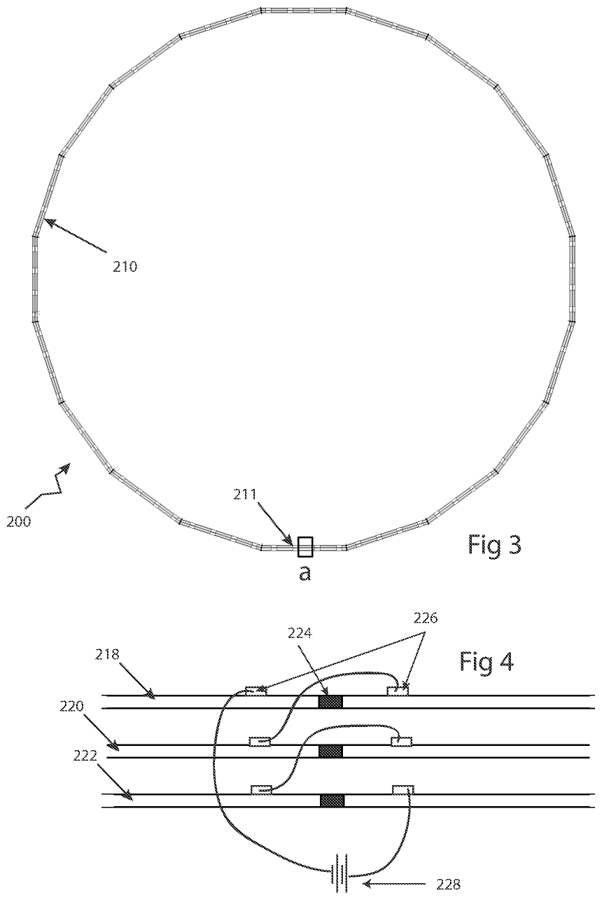

Referring to FIG. 3 is transmitter coil 200. The transmitter coil is the structure upon which all of the other components of the towed survey assembly are supported. It is formed by connecting 19 structural members 210 and 1 crossover structural member 211 together to form what is essentially an approximate circle. The radius of the circular transmitter coil 200 is 15 metres and the area is approximately 706 m2.

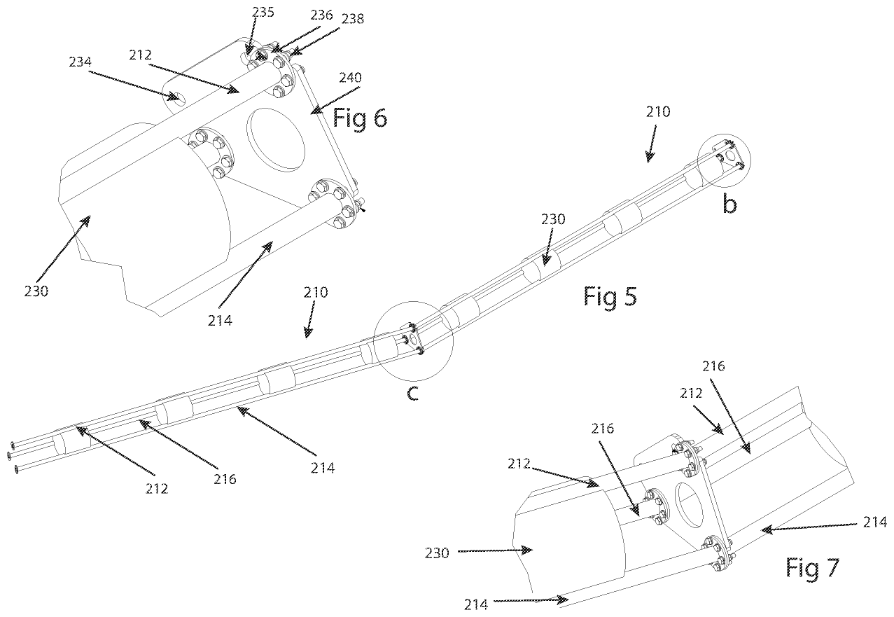

The composition of the structural members 210 is best shown with respect to FIGS. 5 to 8. In these figures it can be seen that each structural member 210 is made of three structural elements 212, 214 and 216. These elements are formed from a rigid and conductive material. In the present embodiment they are made from aluminium (5000 series grade aluminium) formed into a straight hollow pipe with flange sections 236 formed at either end of the elements.

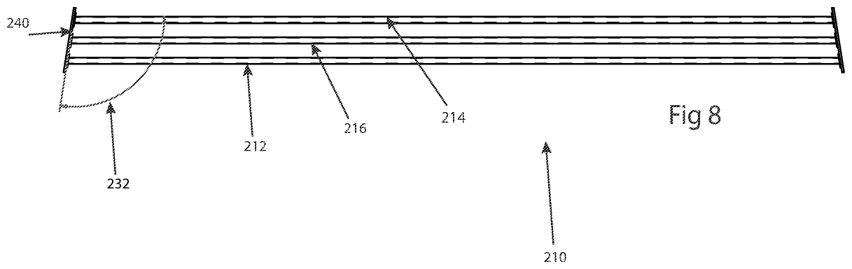

The structural elements 212, 214 and 216 are insulated. The uninsulated flanged sections 236 allow elements 212, 214 and 216 to be connected with corresponding elements in adjacent structural members 210. So that the current does not short circuit at the junctions between structural members 210, plates 240, made from nylon, are provided that are non-conductive and therefore prevent any current from flowing out of the elements 212, 214 and 216. By providing plates 240 with predrilled holes for bolts and nut assemblies 238, even spacing can be provided between the structural elements 212, 214 and 216. Styrofoam spacers 230 can also be provided to keep the elements equal distance apart. A single structural member 210 is shown in FIG. 8. The angle formed 232 between the structural elements 212, 214 and 216 and end plate 240 is 99 degrees.

If 20 structural members 210 are utilised, the result is three independent loops of conductive material. A transmitting coil is made more powerful when it utilises multiple windings or turns in a single circuit or coil. Accordingly to turn this three ringed structure into a wound coil, a cross over member 211 is utilised in the place of one structural member 210.

Referring to FIG. 4, a detailed section of cross over member 211 is shown. In FIG. 4 it can be seen that each element 218, 220 and 222 have interposed along their length, an insulator 224 which prevents the current from running through the elements at that point. In order to generate a coil, there are provided electrical contacts 226 on either side of insulator 224. These are then connected as shown in FIG. 4 with the transmitter 228 which provides the power to the coil 200. Once connected as depicted, a single electrical circuit is formed with three windings or turns.

Additional structural elements may be added to each structural member 210 to provide for additional windings. For example, instead of three structural elements per structural member, four, five or more structural elements can be included in each structural member with a correspondingly designed cross over member can be utilised to turn the conductive structural elements into a single conducting circuit or coil.

It is preferred that the cross over member 211 carry all of the generator and transmitter as these need to be connected together with the wiring shown in FIG. 4. This can add extra weight to the coil 200 at that point. So any structural segment that bears this additional weight can preferably have extra structural components added to it to prevent it from bending or warping due to the extra weight.

In FIG. 6 there is depicted aperture 234 which is used to connect a lateral rope (not shown—13.86 m each) which extends from the aperture 234 to the centre of the coil where the transmitter is located. The transmitter itself is suspended by four ropes and so the lateral ropes do not bear much of the weight of the transmitter and are there principally to maintain the integrity of the coil 200, particularly while lifting off the ground and returning the coil 200 to the ground. Aperture 235 is used to connect the coil 200 to lifting ropes which connected it to the lifting aircraft or helicopter. Each of the lifting ropes is of a length to provide a lifting attitude similar to the one shown in FIG. 1 when in use.

Turning to the embodiment shown in FIGS. 3 to 8, the following parameters apply:
the transmitter coil 200 has an area of approximately 706 m2;
weighs approximately 11 kg per structural segment or approximately 220 kg in total.
each structural member 210 is 4630 mm in length at its shortest (the inner edges of the end plates 240—see top of FIG. 8) and 4779 mm in length at its longest (the outer edges of the opposite ends of the end plates 240—the bottom of FIG. 8). The three lengths of the structural elements are, 4733 mm for structural element 212, 2693 for structural element 216 and 4654 mm for structural element 214.
the transmitter coil has 282 metres of conductors in total length wrapped around the coil in three turns.
The resistance in OHMS of the conductors in the coil is 0.04 OHM and the current that is able to be safely conducted by the conductors is approximately 400 amps (operating at 28 volts).
Power is derived from two 3.2 kw petrol generators and supplied to the transmitter.

When the helicopter is stationary, the apparatus will be at an angle (approximately 30 degrees) and so one part of coil 200 will contact first when it is lowered to the ground. The transmitter coil 200 is both flexible and sufficiently rigid that the coil 200 can be lowered and raised off the ground.

The utilisation of structural elements as conductors has made it possible to generate greater magnetic fields and dipole moments compared to conventional coils of similar weight and/or sizes.

While the invention has been described with reference to preferred embodiments above, it will be appreciated by those skilled in the art that it is not limited to those embodiments, but may be embodied in many other forms, variations and modifications other than those specifically described. The invention includes all such variation and modifications. The invention also includes all of the steps, features, components and/or devices referred to or indicated in the specification, individually or collectively and any and all combinations or any two or more of the steps or features.

In this specification, unless the context clearly indicates otherwise, the word “comprising” is not intended to have the exclusive meaning of the word such as “consisting only of”, but rather has the non-exclusive meaning, in the sense of “including at least”. The same applies, with corresponding grammatical changes, to other forms of the word such as “comprise”, etc.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs.

Any promises made in the present document should be understood to relate to some embodiments of the invention, and are not intended to be promises made about the invention in all embodiments. Where there are promises that are deemed to apply to all embodiments of the invention, the applicant/patentee reserves the right to later delete them from the description and they do not rely on these promises for the acceptance or subsequent grant of a patent in any country.

1. A transmitter coil adapted for use in aerial electromagnetic surveying wherein the transmitter coil comprises at least one structural member that is configured to form at least one conductive loop and adapted to have current from a transmitter module pass through the at least one structural member to generate a magnetic moment.

2. The transmitter coil of claim 1 wherein the transmitter coil is comprised of a plurality of conductive loops.

3. The transmitter coil of claim 1 wherein there are a plurality of structural members.

4. The transmitter coil of claim 3 wherein the plurality of structural members comprises a plurality of structural elements that are elongate, rigid and conductive and wherein each structural element form part of the plurality of conductive loops.

5. The transmitter coil of claim 4 wherein each structural member has two joining end plates at either end of the plurality of elongate structural elements and wherein the end plates are made from a non-conductive material and wherein each end plate is used to connect one structural member with a nearby structural member.

6. The transmitter coil of claim 5 wherein the structural elements from two adjacent structural elements joined by their respective non-conductive end plates are in electrical connection by way of conductive bolts that extend through the non conductive end plates and connect flange portions of the structural elements.

7. The transmitter coil of claim 4, wherein the structural elements are separated by insulating spacers.

8. The transmitter coil of claim 1, wherein the number of conductive loops is three and the number of structural elements per structural member is three.

9. The transmitter coil of claim 8 comprising a plurality of structural members which form an almost complete circle comprising three separate conductive loops and a cross over member, where the cross over member is adapted to conduct the current between the structural elements such that they form one conductive circuit or path that has three winds or turns around the transmitter coil.

10. The transmitter coil of claim 9 wherein the cross over member comprises:
three insulated structural elements that conduct current with their adjacent and connected structural elements in adjacent and connected structural members but that contain a central insulator which prevents the current flowing through the insulated structural elements and where the central insulator divides the insulated structural elements into two electrically insulated portions, and
wires for connecting
a first portion of a first insulated structural element to a first terminal of the power source (transmitter),
a second portion of the first insulated structural element to a first portion of the second insulated structural element;
a second portion of the second insulated structural element to the first portion of the third insulated structural element; and—from the second portion of the third insulated structural element to the other terminal of the power source (transmitter).

11. The transmitter coil of claim 10 wherein there are 19 structural members and
1 cross over member provided of equal length and wherein the structural members and cross over member have end plates angled at approximately 99 degrees relative to the structural elements such that when connected by their end plates, the transmitter coil is substantially circular with a diameter of 15 metres.

12. The transmitter coil of claim 11 wherein the structural elements are aluminium pipes and wherein each structural member weighs around 11 kg in total.

13. The transmitter coil of claim 12 wherein the total weight of the transmitter coil is approximately 220 kg.

14. The transmitter coil of claim 13 wherein the total current through the conductive elements is 400 amps.

15. A surveying apparatus comprising:
a transmitter coil comprising at least one structural member that is configured to form at least one conductive loop and adapted to have current from a transmitter module pass through the at least one structural member to generate a magnetic moment;
at least one generator for generating power;
a transmitter for generating a primary field through the transmitter coil, and
a receiver for receiving a secondary field generated by the primary field.
